(19) United States
(12) Patent Application Publication
(10) Pub. No.: US 2011/0242933 A1
(43) Pub. Date: Oct. 6, 2011

(54) DETERMINING A CHARACTERISTIC OF A SEISMIC SENSING MODULE USING A PROCESSOR IN THE SEISMIC SENSING MODULE

(76) Inventors: Francis Maissant, Oslo (NO); Daniel Ronnow, Oslo (NO); Simon Barakat, Chilly-Mazarin (FR)

(21) Appl. No.: 12/189,147

(22) Filed: Aug. 9, 2008

Related U.S. Application Data
(60) Provisional application No. 60/981,141, filed on Oct. 19, 2007.

(51) Int. Cl. H04B 17/00

(52) U.S. Cl. 367/13

(57) ABSTRACT

A seismic sensing module comprises a seismic sensing element and a processor configured to generate a test signal applied to the seismic sensing element, receive a response from the seismic sensing element, and determine a characteristic of the seismic sensing module according to the response.

### CROSS-REFERENCE TO RELATED APPLICATIONS

This application claims the earlier effective filing date of co-pending Provisional U.S. patent application Ser. No. 60/981,141, filed on 19 Oct., 2007, having the same title, by the same inventors.

### TECHNICAL FIELD

The invention relates to determining a characteristic of a seismic sensing module using a processor in the seismic sensing module.

### BACKGROUND

Seismic surveying is used for identifying subterranean elements, such as hydrocarbon reservoirs, fresh water aquifers, gas injection reservoirs, and so forth. In performing seismic surveying, seismic sources and seismic sensors can be placed at various locations on an earth surface (e.g., a land surface or a sea floor), or even in a wellbore, with the seismic sources activated to generate seismic waves. Examples of seismic sources include explosives, air guns, acoustic vibrators, or other sources that generate seismic waves.

Some of the seismic waves generated by a seismic source travel into a subterranean structure, with a portion of the seismic waves reflected back to the surface (earth surface, sea floor, or wellbore surface) for receipt by seismic sensors (e.g., geophones, hydrophones, etc.). These seismic sensors produce signals that represent detected seismic waves. Signals from the seismic sensors are processed to yield information about the content and characteristics of the subterranean structure.

A seismic sensor is typically tested. Conventionally, use of a highly accurate signal generator, which is separate from a seismic sensor, is usually required. The presence of the high accuracy signal generator adds complexity and cost to a seismic survey system.

### SUMMARY

In general, according to an embodiment, a method of testing a seismic sensing module includes generating, using a local processor associated with a seismic sensing element in the seismic sensing module, a test signal that is applied to the seismic sensing element, and receiving, by the local processor, a response of the seismic sensing element to the test signal. The local processor determines at least one characteristic of the seismic sensing module, where the at least one characteristic is selected from a polarity of the seismic sensing element in the seismic sensing module, a non-linear property of the seismic sensing module, and a temperature-dependent transfer function of the seismic sensing module.

In general, according to another embodiment, a self-contained seismic sensing module includes a single housing that contains a seismic sensing element, and a processor. The processor is configured to generate a test signal applied to the seismic sensing element, receive a response from the seismic sensing element, and determine a characteristic of the seismic sensing module according to the response.

Other or alternative features will become apparent from the following description, from the drawings, and from the claims.

### BRIEF DESCRIPTION OF THE DRAWINGS

FIG. 1 illustrates an example marine survey arrangement.

FIG. 2 is a block diagram of a self-contained seismic sensing module according to an embodiment.

FIG. 3 is a graph of curves representing step responses over time to various input step voltages.

FIG. 4 is a graph of curves representing measured step response data at a certain time and an ideal step response.

FIG. 5 is a graph of a curve representing a step response with the ideal step response subtracted.

FIGS. 6A-6B illustrate different polarity connections to a seismic sensing element.

FIGS. 7A-7B and 8A-8B are graphs of curves representing positive step responses and negative step responses for different polarity connections of the seismic sensing element.

FIGS. 9A-9B are graphs of curves representing a reference acceleration for use in developing a temperature-dependent transfer function.

FIGS. 10A-10B are graphs of curves representing the change in transfer function with temperature at one frequency.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

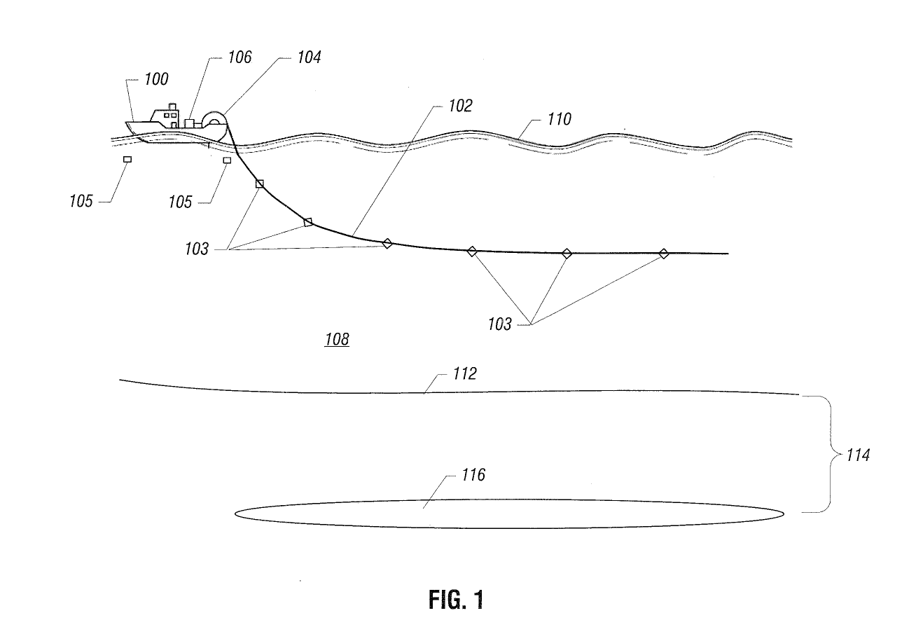

FIG. 1 illustrates an example arrangement to perform marine seismic surveying. In different implementations, however, other embodiments can involve seabed seismic surveying, land-based seismic surveying or wellbore seismic surveying. FIG. 1 illustrates a sea vessel 100 that has a reel or spool 104 for deploying a streamer 102 (or multiple streamers 102), where the streamer 102 is a cable-like carrier structure that carries a number of electronic devices 103 for performing a subterranean survey of a subterranean structure 114 below a sea floor 112. In the following, the term “streamer” is intended to cover either a streamer that is towed by a sea vessel or a sea bed cable laid on the sea floor 112.

The electronic devices 103 can include sensing modules, steering or navigation devices, air gun controllers (or other signal source controllers), positioning devices, and so forth. Also depicted in FIG. 1 are a number of signal sources 105 that produce signals propagated into the body of water 108 and into the subterranean structure 114. Although the sources 105 are depicted as being separate from the streamer 102, the sources 105 can also be part of the streamer 102 in a different implementation.

The signals from the sources 105 are reflected from layers in the subterranean structure 114, including a resistive body 116 that can be any one of a hydrocarbon-containing reservoir, a fresh water aquifer, a gas injection zone, and so forth. Signals reflected from the resistive body 116 are propagated upwardly toward the sensing modules of the streamer 102 for detection by the sensing modules. Measurement data is collected by the sensing modules, which can store the measurement data and/or transmit the measurement data back to a control system (or controller) 106 on the sea vessel 100.

The sensing modules of the streamer 102 can be seismic sensing modules, such as hydrophones and/or geophones. The signal sources 105 can be seismic sources, such as air guns, vibrators, or explosives. Seismic data recorded by the seismic sensing modules on the streamer are provided back to a control system (controller) 106 on the sea vessel. The control system 106 can process the collected seismic data to develop an image of the subterranean structure 114.

In accordance with some embodiments, the seismic sensing modules can each be locally associated with test circuitry to perform a test on the respective seismic sensing module so that a characteristic of the sensing module can be determined, where the characteristic can include non-linear properties of the sensing module, a polarity of the sensing module, and/or a temperature-dependent transfer function of the sensing module. In some embodiments, the test circuitry can be integrated with the sensing module such that a self-contained sensing module is provided. More generally, test circuitry is “locally associated” with the seismic sensing module if the test circuitry is located proximate the seismic sensing module (rather than being located at a relatively far location such as on the sea vessel 100).

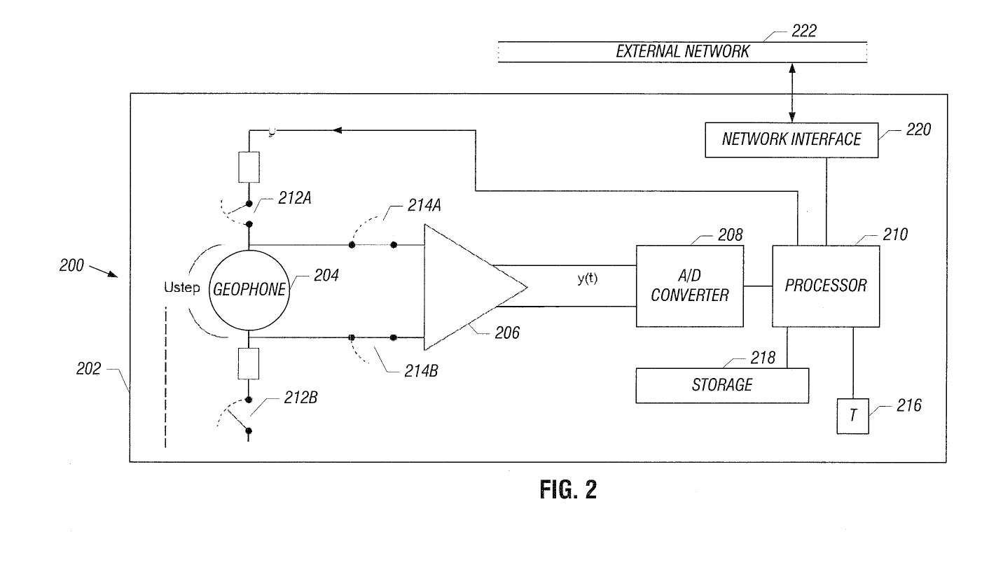

FIG. 2 shows an example embodiment of a self-contained sensing module 200, which has an external housing 202 that contains various components. The components contained in the housing 202 of the sensing module 200 include a seismic sensing element 204, such as a moving coil geophone, accelerator geophone, or other type of seismic sensing element. In response to a step input (input test signal), represented as Ustep, which is generated during a testing procedure of the sensing module 200, the geophone 204 produces an output that is amplified by an amplifier 206. The amplifier 206 produces an output signal representing the step response, y(t), that is responsive to the step input Ustep.

The output signal representing y(t) is provided to the input of an analog-to-digital (A/D) converter 208, which converts the analog output signal representing y(t) to digital data. The digital step response is then processed by a processor 210. The processor 210 can be implemented with a digital signal processor (DSP), a general purpose microprocessor, or any other type of processing element.

The step input Ustep is generated based on an applied input voltage U, provided by the processor 210 directly or indirectly (through other circuitry). The processor 210 also controls geophone test switches 212A and 212B, where the geophone test switch 212A connects the input voltage U to one side of the seismic sensing element 204, and the other geophone test switch 212B connects the other side of the seismic sensing element 204 to a reference voltage, such as ground. The processor 210 also controls another set of switches 214A, 214B, which connect the output of the geophone 204 to the input of the amplifier 206. The switches 214A, 214B are referred to as amplifier switches.

Note that during normal operation, which is operation of the sensing module 200 in the field for performing a seismic survey, the geophone test switches 212A, 212B remain open, whereas the amplifier switches 214A, 214B remain closed. In this “normal” configuration, the seismic sensing element 204 is able to detect a seismic input, such as in the form of an acoustic wave reflected from the subterranean structure, to produce an output representing acceleration. The acceleration includes the second derivative with respect to time of ground displacement, or first derivative of the velocity.

However, during a test operation for testing the sensing module 200, the amplifier switches 214A, 214B are initially open to isolate the output of the seismic sensing element 204 from the input of the amplifier 206. Moreover, the geophone test switches 214A, 214B are also initially open such that no input is applied to the seismic sensing element 204. To apply the input step, Ustep, to the seismic sensing element 204, the geophone test switches 212A, 212B are closed. Note that the time constant of the switches 212A, 212B is much smaller than a time constant of the seismic sensing element 204 (in other words, the response time of the test switches 212A, 212B is much faster than the response time of the seismic sensing element 204). Simultaneously, or almost simultaneously, with the closing of the geophone test switches 212A, 212B (to apply the input step signal Ustep), the amplifier switches 214A, 214B are also closed. Note that the response time of the amplifier switches 214A, 214B is also much faster than the response time of the seismic sensing element 204. Thus, by the time that the seismic sensing element 204 has responded to application of the input step signal Ustep, the amplifier switches 214A, 214B are already closed to allow the output of the seismic sensing element 204 to be provided to the input of the amplifier 206.

To provide fast response times, the switches 212A, 212B and 214A, 214B can be implemented with solid state switches, such as transistors.

The input test voltage U can remain fixed during the entire duration of a test procedure, or alternatively, the input test voltage U can be varied by the processor 210. U can be varied to give constant current through the geophone, e.g., when the geophone resistance changes. The step voltage, Ustep, is then measured separately. In one example, the processor 210 may be coupled to a temperature sensor 216 in the seismic sensing module 200 (or alternatively, to a temperature sensor located externally to the sensing module 200) to receive temperature data regarding an environment of the sensing module 200. The processor 210 can vary the input test voltage U based on the temperature measurement, since the processor 210 may have to take into account variations in the response of the seismic sensing element 204 due to temperature variation.

From the step response produced by the seismic sensing element 204 as a result of the input test signal, the processor 210 determines a characteristic of the sensing module 200. The determined characteristic can include a polarity of the seismic sensing element 204, a temperature-dependent transfer function of the seismic sensing module 200, and/or a characterization of non-linear properties in a signal acquisition chain of the seismic sensing module 200 including the seismic sensing element 204, the amplifier 206, the A/D converter 208, and so forth.

Information regarding the determined characteristics can be stored in a storage 218 (e.g., memory, persistent storage, etc.) that is in the sensing module 200. Note that the storage 218 can be part of the processor 210. Also, in some cases, the processor 210 is able to communicate information regarding the determined characteristics through a network interface 220 (located inside the seismic sensing module 200) to an external network 222. Note that the external network 222 can be part of the streamer 102 depicted in FIG. 1. The external network 222 can be implemented with an electrical cable, a fiber optic cable, a wireless communication medium, and so forth.

The network interface 220 in the seismic sensing module 200 includes various protocol layers to allow for communication over the external network 222, including a physical layer, data link layer, and higher layers. In one example implementation, the network interface 220 can include Transmission Control Protocol (TCP)/Internet Protocol (IP) layers to allow for communication of control signals and data in TCP/IP packets over the external network 222. In other implementations, the external network 222 can be a simpler network, such as a network that includes a control line and a data line. Also, the external network 222 can be considered to include a power line to provide power to the sensing module 200.

The self-contained seismic sensing module 200 of FIG. 2 integrates a seismic sensing element (204) with test circuitry that is implemented with the test switches 212A, 212B, amplifier switches 214A, 214B, and the local processor 210, in the illustrated example. Integrating the test circuitry with the seismic sensing element within the housing 202 of the seismic sensing module 200 enables for more efficient and convenient testing of the seismic sensing module 200. Note that the various components that are contained within the seismic sensing module 200 can be provided on a circuit board. For example, the switches 212A, 214B, 214A, 214B, amplifier 206, A/D converter 208, processor 210, storage 218, and network interface 220 can be implemented with one or more integrated circuit chips that are mounted on the circuit board, where the circuit board is contained within the housing 202 of the seismic sensing module 200.

### Non-Linearity Testing

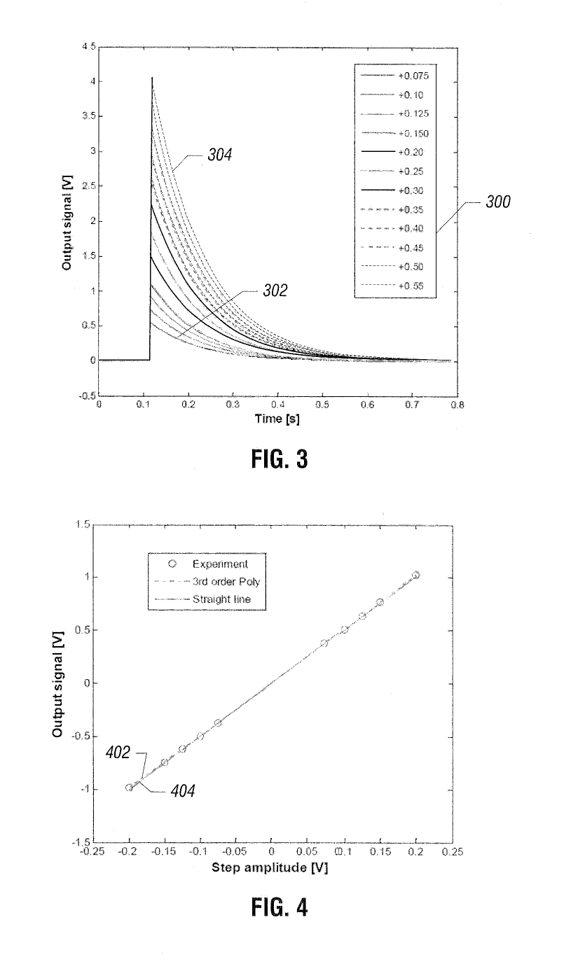

As noted above, one of the characteristics of the seismic sensing module 200 that can be determined includes non-linear property(ies) of a signal acquisition chain inside the sensing module 200. A seismic sensing module is considered to be non-linear if a response of the sensing module varies non-linearly with different amplitudes of an input test voltage. For example, FIG. 3 shows a number of (non-linear) step responses, y(t), for different input step voltages, Ustep. A step voltage steps from an initial voltage level (e.g., 0 volts) to a second, different voltage level, which is indicated in the legend 300 in FIG. 3, where the example step voltages include +0.075, +0.10, +0.125, and so forth. The curves depicted in FIG. 3 represent the output signal voltage produced by the seismic sensing element 204 as a function of time. Thus, for example, a first curve 302 represents the step response y(t) responsive to a step voltage of +0.075 volts (the input step voltage steps from 0 to +0.075 volts). Similarly, another curve 304 represents the step response, y(t), responsive to a step voltage of +0.55 volts (the input step voltage is stepped from 0 to +0.55 volts). Although not depicted in FIG. 3, the input step voltages can also be negative step voltages, which means that the input test voltage steps from 0 to a negative voltage.

The step response y(t) is a function both of time and the applied input step voltage, U, i.e., y=y(t,U). The step response y(t,U) varies close to linearly with U. Therefore, an assumption can be made that y(t,U) can be approximately described by a Taylor series, i.e., a polynomial:

y(t,U)≈h₀(t)+h₁(t)U+h₂(t)U²+ . . . . (Eq. 1)

In FIG. 4, the step response y(t), is shown as a function of an input step voltage U for the time t=0.1579 s in the example. Each circle in FIG. 4 represents an experimental data point (voltage value at the particular U at time t=0.1579 s). The experimental data points in FIG. 4 are fitted (third order polynomial fit) to a curve 402 (dashed curve). FIG. 4 also depicts a straight line 404 that represents an ideal linear step response. Note that there is a slight difference between curves 402 and 404 due to non-linearities of the seismic sensing module 200.

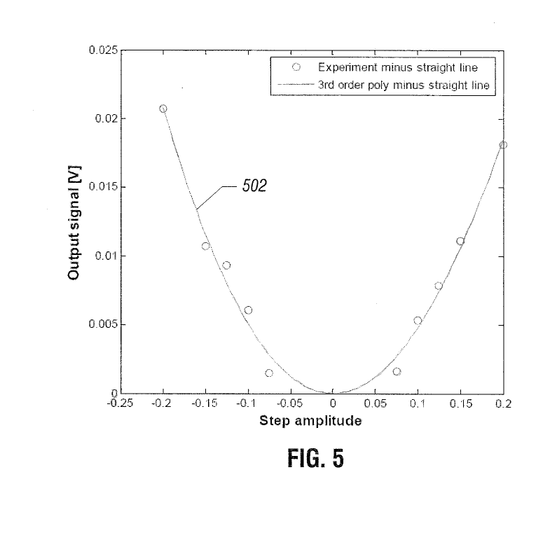

FIG. 5 shows the output signal voltage of the sensing module 200 with the straight line (404 in FIG. 4) subtracted from the data (in other words, FIG. 5 shows just the non-linear part of the response). The circles in FIG. 5 indicate measured data values minus the straight line 404 of FIG. 4, while the curve 502 in FIG. 5 is a third order polynomial fit of the data values depicted in FIG. 5. The curve 502 represents the curve 402 of FIG. 4 minus the straight line 404.

The non-linearity of the seismic sensing module 200 is the difference between the measured data points (as fitted onto dashed curve 402) and the solid straight line 404 (one example of a linear response of the seismic sensing module). In one implementation, the non-linearity of the sensing module 200 can be expressed using some predefined measure of non-linearity, such as a measure INL that is expressed as:

$$INL = \frac{1}{M} {\sum }_{m = 1}^{M} \frac{1}{N} {\sum }_{n = 1}^{N} \vert {y}^{exp} ( {t}_{m} , {U}_{n} ) - {y}^{lin} ( {t}_{m} , {U}_{n} ) \vert , \qquad ( Eq . 2 )$$

Note that FIG. 4 represents y(t,U) as a function of different U values at a specific fixed time t. The example of FIG. 4 is for time t=0.1579 s. FIG. 4 can be repeated for other time points (which correspond to the time points along the time axis of FIG. 3). If FIG. 4 represents the response y(t₁,U) at time point t₁, then the other step responses at different time points can be expressed as y(t₂, U), y(t₃, U), . . . , y(t_{M}, U), where M is an integer representing the number of time points that are considered.

In determining the non-linearity measure INL, the absolute value of the difference between the fitted curve 402 (e.g., third-order polynomial fit), represented as y^{exp}(tₘ,Uₙ), and the straight line 404, represented as y^{lin}(tₘ,Uₙ), is determined and summed over Uₙ values for n from 1 to N. The sum of the difference values is divided by N to determine an average over the multiple Uₙ values.

Note that Eq. 2 also specifies summation over different time points, tₘ for m=1 to M, with the summation of the differences over different time points divided by M to average over the number of time points taken. Effectively INL is calculated based on summing differences between y^{exp} and y^{lin} over multiple (N) input step voltages U and multiple (M) time points t, and dividing the sum by M×N to obtain an average of the differences.

The non-linearity measure INL can be stored in the storage 218 (FIG. 2) of the sensing module 200, or the non-linearity measure INL can be communicated over the external network 222 to a central controller, such as control system 106 in FIG. 1. If stored in the sensing module 200, the processor 210 is able to perform self-calibration of the measurement taken with the sensing module 202 to compensate for non-linear properties of the sensing module 200.

The following describes a more specific implementation for calculating an INL measure to represent non-linearity of a seismic sensing module. The step voltages are denoted U₁, U₂, . . . , Uₙ, . . . , U_{N}. For each step voltage, a step response is measured: y(tₘ,Uₙ), where n=1, 2, . . . , N and tₘ is the time and m=1, . . . , M is the number of samples.

For each m, the experimental data is fitted to a third-order polynomial:

y_{fit}(tₘ,Uₙ)=cₘ⁽¹⁾Uₙ+cₘ⁽²⁾Uₙ²+cₘ⁽³⁾Uₙ³, (Eq. 3)

where the coefficients cₘ⁽ⁱ⁾ are obtained by minimizing:

$${ξ}_{m} = {\sum }_{n}^{N} {( y ( {t}_{m} , {U}_{n} ) - {y}_{fit} ( {t}_{m} , {U}_{n} ) )}^{2} . \qquad ( Eq . 4 )$$

Eq. 3 is written as a matrix:

$$( \begin{matrix}{U}_{1} & {U}_{1}^{2} & {U}_{1}^{3} \\ {U}_{2} & {U}_{2}^{2} & {U}_{2}^{3} \\ ⋮ & ⋮ & ⋮ \\ {U}_{N} & {U}_{N}^{2} & {U}_{N}^{3}\end{matrix} ) ( \begin{matrix}{c}_{m}^{( 1 )} \\ {c}_{m}^{( 2 )} \\ {c}_{m}^{( 3 )}\end{matrix} ) = ( \begin{matrix}y ( , {U}_{1} ) \\ y ( , {U}_{2} ) \\ ⋮ \\ y ( , {U}_{N} )\end{matrix} ) , \qquad ( Eq . 5 )$$

or Uc=y. The polynomial coefficient vector c is obtained by a fitting in a least square sense:

c=(U^{H}U)⁻¹U^{H}y, (Eq. 6)

where U^{H} is the hermitian transpose of the matrix U. Here U is real and U^{H}=U^{T}, where U^{T} is the transpose.

Using the linear term, the step response data y(tₘ,Uₙ) is normalized:

$${y}_{norm} ( {t}_{m} , {U}_{n} ) = \frac{y ( {t}_{m} , {U}_{n} )}{{c}_{m}^{1}} . \qquad ( Eq . 7 )$$

The nonlinear part, i.e., the difference between yₙₒᵣₘ(tₘ,Uₙ) and a straight line, is calculated at each (tₘ,Uₙ):

y_{NL}(tₘ,Uₙ)=yₙₒᵣₘ(tₘ,Uₙ)−Uₙ. (Eq. 8)

The average integrated nonlinearity measure, Avg_INL, is calculated as follows:

$$Avg\_INL = \frac{1}{MN} {\sum }_{m = 0}^{M - 1} {\sum }_{n = 1}^{N} \vert {y}_{NL} ( {t}_{m} , n ) \vert \qquad ( Eq . 9 )$$

Instead of using the non-linear measure INL (or Avg_INL) as discussed above, a different way to express non-linear properties of the seismic sensing module 200 is by use of a total harmonic distortion (THD) measure in the case that the input test signal is a sinusoidal with angular frequency ω. The output response of the sensing module 200 is considered to have signal components at various frequencies, including the following angular frequencies: ω, 2ω, 3ω, 4ω, . . . . The signal component at 2ω represents the second order harmonic, the signal component at 3ω represents the third order harmonic, and so forth. The THD measure is calculated as the sum of the power at frequencies 2ω, 3ω, 4ω, and so forth.

The computation of THD according to one example implementation is described below. The THD, which is a standard measure, could be calculated from the coefficients c₁, c₂, . . . , as determined from the step test (see Eq. 6). The input test signal can be written as:

x(t)=A cos(ωt), (Eq. 10)

where A is the amplitude and ω is the angular frequency.

If it is assumed that the non-linear system can be described by a 4th order polynomial, with the polynomial coefficients c₁, . . . , c₄, the following output signal is obtained:

$$\begin{matrix}y ( t ) = {c}_{1} A cos ( ω t ) + {c}_{2} {A}^{2} {cos ( ω t )}^{2} + {c}_{3} {A}^{3} {cos ( ω t )}^{3} + \\ {c}_{4} {A}^{4} {cos ( ω t )}^{4} \\ = {c}_{1} A cos ( ω t ) + \frac{{c}_{2} {A}^{2}}{2} ( 1 + cos ( 2 ω ) ) + \\ \frac{{c}_{3} {A}^{3}}{4} ( cos ( 3 ω t ) + 3 cos ( ω t ) ) + \\ \frac{{c}_{4} {A}^{4}}{4} ( \frac{3}{2} + 2 cos ( 2 ω t ) + \frac{1}{2} cos ( 4 ω t ) )\end{matrix} \qquad ( Eq . 11 )$$

The relative amplitude (in linear scale) at 2ω (neglecting the contributions from c₆, c₈, . . . ) is as follows:

$$HD ( w ) = \frac{{c}_{2} A}{2 {c}_{1}} + \frac{{c}_{4} {A}^{3}}{4 {c}_{1}} \qquad ( Eq . 12 )$$

The relative amplitude at 3ω (neglecting the contributions from c₅, c₇, . . . ) is as follows:

$$HD ( 3 ω ) = \frac{{c}_{3} {A}^{2}}{4 {c}_{1}} . \qquad ( Eq . 13 )$$

The relative amplitude at 4ω (neglecting the contributions from c₆, c₈, . . . ) is as follows:

$$HD ( 4 ω ) = \frac{{c}_{4} {A}^{3}}{8 {c}_{1}} . \qquad ( Eq . 14 )$$

Assuming just the harmonics 2ω, 3ω, and 4ω are considered, the total harmonic distortion, THD, can then be calulated as:

THD=HD(2ω)+HD(3ω)+HD(4ω), (Eq. 15)

which is normally given in dB.

Thus, if the polynomial coefficients c₁, c₂, c₃, c₄ are known, the THD can be calculated for a given amplitude A.

More generally, the non-linear properties of a seismic sensing element are determined from a number of voltage steps of different amplitudes. The voltage steps are applied to the seismic sensing element, with the step response recorded in the time domain. The non-linear properties are taken as the step response's deviation from a straight line as a function of applied step voltage.

By determining the non-linear properties of the seismic sensing element, distortion in the recorded seismic signal can be removed or reduced. Also, in some cases, if it is detected that a seismic sensing element is exhibiting excessive non-linear properties, then the corresponding seismic sensing module 200 can be removed or disabled from operation or service.

Determining the non-linear characteristic of the sensing module 200 can be performed in the field (such as during a land seismic surveying operation, a marine seismic surveying operation, or a wellbore seismic surveying operation). The processor local test circuitry in each seismic sensing module 200 can also be used for production testing of the sensing module 200, which can be cheaper and faster than testing that involves use of an external signal generator.

Techniques according to some embodiments can be applied to different types of seismic sensing elements, including geophone accelerometers, moving coil geophones, velocimeters, microelectro-mechanical systems (MEMS) accelerometers, and so forth.

### Polarity Testing

When assembling seismic sensing elements onto one or plural streamers, or in some other seismic spread, which involves the connection of electrical wires to the seismic sensing elements, the polarities of wire connections to the seismic sensing elements can be inadvertently reversed. Note that a seismic surveying system can include a relatively large number of seismic sensing elements (e.g., thousands, tens of thousands, hundreds of thousands), such that it would be easy to reverse the wire connections to some of the seismic sensing elements. Reversing the wire connections to seismic sensing elements would result in inaccurate measurement data being collected from the corresponding seismic sensing elements, which can adversely affect accuracy of the seismic surveying operation.

To avoid having to use an external impulse to perform polarity testing, the self-contained seismic sensing module 200 (FIG. 2) according to some embodiments can be used to perform self-testing to detect for reversed polarity of the seismic sensing element 204 contained in the sensing module 200. In accordance with some embodiments, the processor 210 in the sensing module 200 is used for applying a positive input test voltage step and a negative input test voltage step to the seismic sensing element 204. The positive and negative input voltage steps cause the seismic sensing element 204 to produce output signals of different amplitudes. The amplitudes of the output signals responsive to the positive and negative input voltage steps depend upon the connected polarity of the seismic sensing element 204. Based on these detected amplitudes, it can be determined whether the polarity of the wire connections to the seismic sensing element is reversed. By using the internal processor 210 to perform the polarity testing, no external impulse source is required.

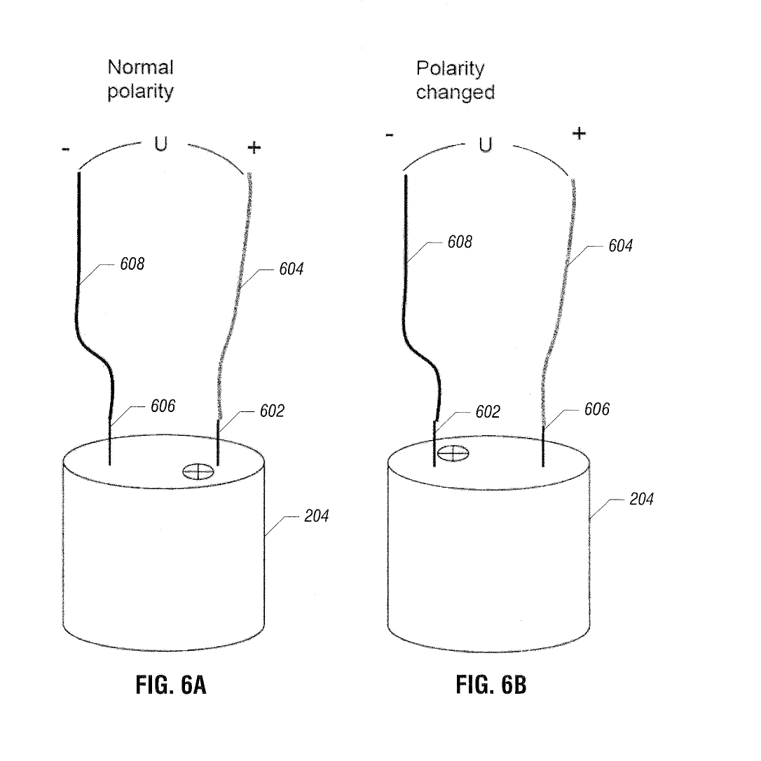

FIG. 6A shows the seismic sensing element 204 having a first polarity (referred to as a normal polarity), with the positive terminal 602 of the seismic sensing element 204 connected to a first wire 604, and a negative terminal 606 of the seismic sensing element 204 connected to a second wire 608. The input voltage U is defined from the first wire 604 to the second wire 608.

FIG. 6B shows the polarity of the seismic sensing element 204 reversed, with the negative terminal 606 connected to the first wire 604, and the positive terminal 602 connected to the second wire 608. It is desired to automatically identify, using the processor 210 of the self-contained seismic sensing module 200, the reversed polarity connection depicted in FIG. 6B.

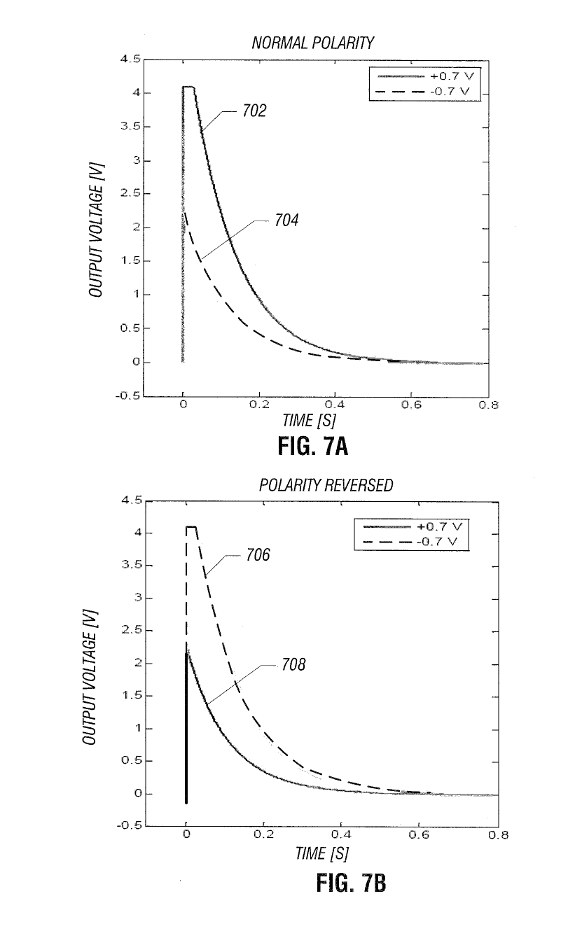

FIG. 7A shows a curve 702 that represents the step response, y(t), responsive to a positive step input voltage (which is +0.7 volts in the example of FIG. 7A). FIG. 7A also shows a second curve 704 that represents the step response, y(t), that is responsive to a negative step input voltage (e.g., −0.7 volts). FIG. 7A shows the expected responses to the positive and negative input steps when the polarity of the seismic sensing element 204 is correct (the polarity depicted in FIG. 6A).

FIG. 7B shows two curves 706, 708, with curve 706 representing the step response, y(t), that is responsive to an applied negative input step, and the curve 708 representing the response, y(t), that is responsive to an applied positive input step. FIG. 7B shows the positive and negative step responses for the seismic sensing element 204 whose polarity has been reversed (FIG. 6B). Thus, as can be seen from a comparison of FIGS. 7A and 7B, the negative step response (706) when the polarity is reversed is much greater than the negative step response when the polarity is normal. Similarly, the positive step response (708) when the polarity is reversed is much smaller than the negative step response (702) when the polarity is normal.

The curves of FIG. 7A can be considered expected profiles of the positive and negative step responses, where the expected profiles can be stored in the storage 218 of the sensing module 200. If the processor 210 determines that the positive and negative step responses of a given seismic sensing element generally match the expected profiles, then the processor 210 produces an indication that the polarity of the seismic sensing element 204 is correct. On the other hand, if the processor 210 detects a substantial difference (difference by greater than predetermined one or more thresholds) between the positive and negative step responses of the seismic sensing element 204 and the expected profiles, then the processor 210 can produce a second indication to indicate that the polarity of the seismic sensing element 204 has been reversed. The indication can be a Boolean indication, where a first state indicates correct polarity, and a second state indicates reversed polarity.

Alternatively, instead of comparing a measured step response to expected profiles, a simple summation of the positive and negative step response can be performed, such as according to Eq. 16 below, to produce an indication of correct polarity or reversed polarity.

The positive step response can be represented as y⁺(t), where t represents time, while the negative step response can be represented as y⁻(t). A number p can be calculated as follows:

$$p = {\sum }_{t}^{ } ( {y}^{+} ( t ) - {y}^{-} ( t ) ) , \qquad ( Eq . 16 )$$

where p is a sum of the difference between the positive step response and the negative step response at plural time points t. If p is greater than zero (p>0) or some other threshold, then the polarity is correct. However, if p is less than zero or some other threshold, (p<0), then the polarity is reversed.

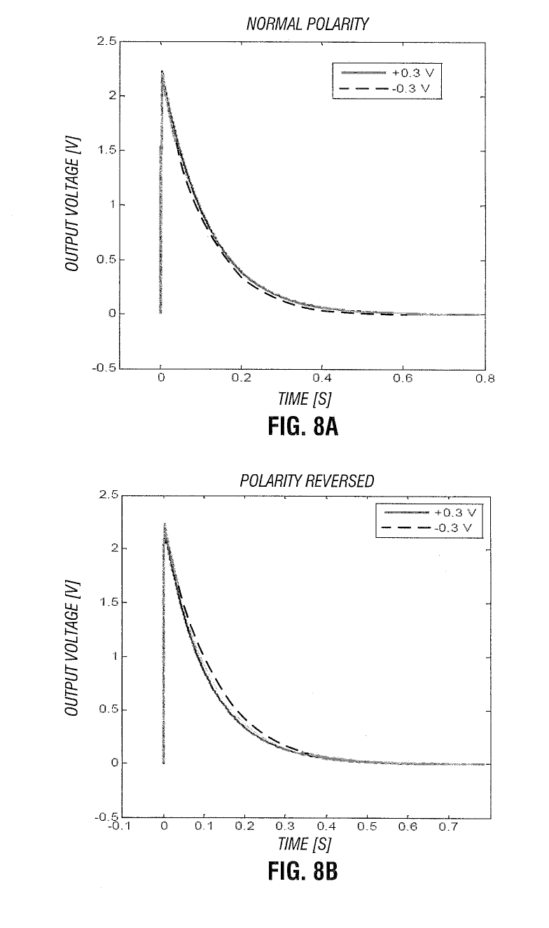

It is noted that in some embodiments, the magnitude of the input step voltage (both the magnitude of the positive input and the magnitude of the negative input step) should be greater than some predetermined threshold. In the example of FIGS. 7A and 7B, the magnitude of the positive and negative input steps is 0.7 volts. In some cases, if the magnitude of the positive and negative input steps drops below the predetermined threshold, such as if the magnitude is 0.3 volts, then the positive and negative step responses may not differ by much for the different polarities of the seismic sensing element 204, which can make detection of reversed polarity difficult. This is illustrated in the example of FIGS. 8A and 8B, where the curves indicate small variations between the positive and negative step responses for different polarities of the seismic sensing element 204.

### Determining Transfer Function of the Seismic Sensing Module

The step response of the seismic sensing module 200 in response to an input test step signal is defined according to a transfer function of the seismic sensing module 200. The transfer function, in the frequency domain, has a first order approximation as follows:

$$H ( ω ) = \frac{Y ( ω )}{{A}^{ref} ( ω )} , \qquad ( Eq . 17 )$$

where A^{ref}(ω) corresponds to the signal that would produce the output signal Y(ω) (frequency domain representation of y(t)) for a given H(ω)). The transfer function can be determined from the measured step response using either a non-parametric method or a parametric method. A parametric method is needed if the geophones have geophone parameters that vary significantly between different units. The non-parametric method is more suitable if different geophones have transfer functions that do not differ significantly, except for when they have different temperature.

For enhanced accuracy, additional terms are added to the transfer function definition according to Eq. 17, where the additional terms are used to compensate for changes of the transfer function due to factors such as changes in temperature and/or other factors.

Y(ω) is the Fourier transform (FFT) of the measured step response, Y(ω)=FFT[y(t)]. A^{ref}(ω) is a reference acceleration, which includes tabulated values obtained from experiments or possibly simulations on the sensing module. Notice that A^{ref}(ω) has to be determined from known Y(ω) and H(ω), and that A^{ref}(ω) is not a step in acceleration. Rather, A^{ref}(ω) is stimuli that would cause the output signal Y(ω), if the system were time invariant.

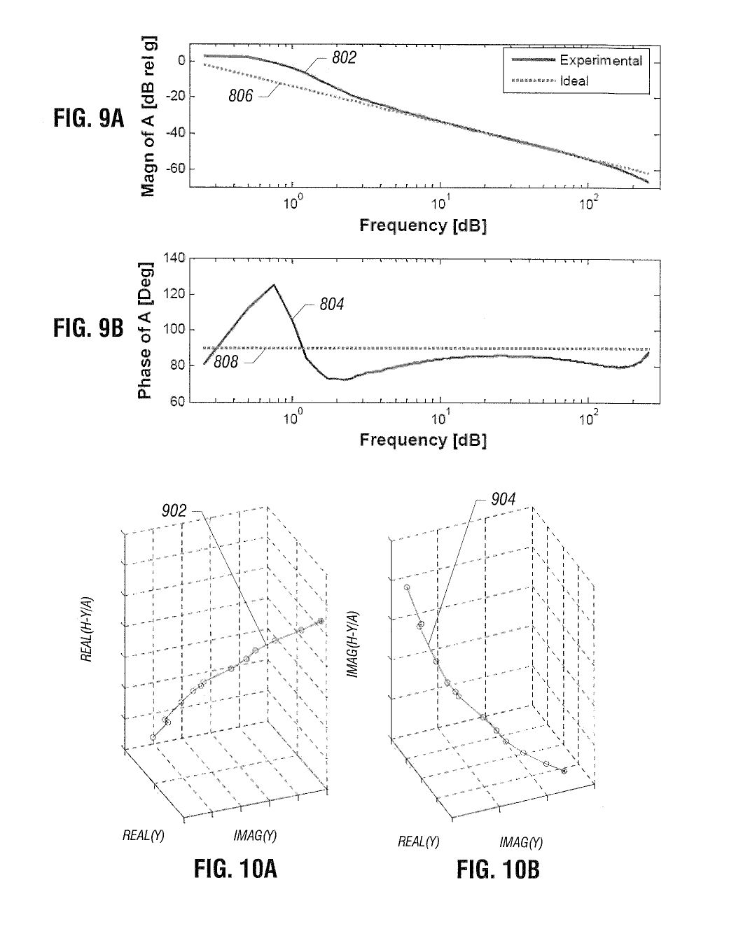

FIGS. 9A and 9B depict A^{ref}(ω) that is determined from experimentation on the sensing module. FIG. 9A shows the magnitude of A^{ref} as a function of frequency (curve 802), and FIG. 9B shows the phase of A^{ref} as a function of frequency (curve 804). The magnitude curve 802 and phase curve 804 are contrasted to the ideal dotted curves 806 and 808 in FIGS. 9A and 9B, respectively, which depict the Fourier transform of an ideal step in acceleration (assuming that the seismic sensing element is an accelerometer). Note that the technique of identifying A^{ref} can also be applied to other types of sensing elements, such as velocimeters and MEMS accelerometers.

As noted above, the transfer function H(ω) is dependent upon external factors such as temperature, such that Eq. 17 may be inaccurate in some scenarios. To add terms to Eq. 17, the following definition of H(ω) is provided:

$$H ( ω ) = \frac{Y ( ω )}{{A}^{ref} ( ω )} + {F}_{r} [ Y ( ω ) ] + j {F}_{j} [ Y ( ω ) ] , \qquad ( Eq . 18 )$$

where Fᵣ[Y(ω)] and jFⱼ[Y(ω)] are temperature-dependent terms,

Fᵣ[Y(ω)]=cᵣ(ω)(Yᵣ(ω)−Yᵣ^{ref}(ω))+cⱼ(ω)(Yᵢ^{ref}(ω))+cᵣᵣ(ω)(Yᵣ(ω)−Yᵣ^{ref}(ω))²+cⱼⱼ(ω)(Yᵢ(ω)−Yᵢ^{ref}(ω))²+cᵣⱼ(ω)Yᵣ(ω)−Yᵣ^{ref}(ω))(Yᵢ(ω)−Yᵢ^{ref}(ω))+cᵣᵣᵣ(ω)(Yᵣ(ω)−Yᵣ^{ref}(ω))³+cⱼⱼⱼ(ω)(Yᵢ(ω)−Yᵣ^{ref}(ω))³+cᵣᵣⱼ(ω)(Yᵣ(ω)−Yᵣ^{ref}(ω))²(Yᵢ(ω)−Yᵢ^{ref}(ω))+cᵣᵣⱼ(ω)(Yᵣ(ω)−Yᵣ^{ref}(ω))(Yᵢ(ω)−Yᵢ^{ref}(ω))²+D(ω),

and

Fᵣ[Y(ω)]=dᵣ(ω)(Yᵣ(ω)−Yᵣ^{ref}(ω))+dⱼ(ω)(Yᵢ^{ref}(ω))+dᵣᵣ(ω)(Yᵣ(ω)−Yᵣ^{ref}(ω))²+dⱼⱼ(ω)(Yᵢ(ω)−Yᵢ^{ref}(ω))²+dᵣⱼ(ω)Yᵣ(ω)−Yᵣ^{ref}(ω))(Yᵢ(ω)−Yᵢ^{ref}(ω))+dᵣᵣᵣ(ω)(Yᵣ(ω)−Yᵣ^{ref}(ω))³+dⱼⱼⱼ(ω)(Yᵢ(ω)−Yᵣ^{ref}(ω))³+dᵣᵣⱼ(ω)(Yᵣ(ω)−Yᵣ^{ref}(ω))²(Yᵢ(ω)−Yᵢ^{ref}(ω))+dᵣᵣⱼ(ω)(Yᵣ(ω)−Yᵣ^{ref}(ω))(Yᵢ(ω)−Yᵢ^{ref}(ω))²+D(ω),

Yᵢ(ω) and Yᵣ(ω) are the real and imaginary parts of the measured step response during a step test, Y(ω). Yᵣ^{ref}(ω) and Yᵢ^{ref}(ω) are the real and imaginary parts of a reference step response. cᵣ(ω), cⱼ(ω), . . . , dᵣ(ω), dⱼ(ω) are constants that are obtained from simulations or measurements of the temperature dependence of the sensing element's transfer function.

The equations above describe a Taylor series in the real and imaginary parts around an operating point. Notice that Yᵣ^{ref}(ω) and Yᵢ^{ref}(ω) are determined from experiments and are then tabulated. The coefficients cᵣ(ω), cⱼ(ω) , . . . , dᵣ(ω), dⱼ(ω) are also determined from experiments or simulations and are tabulated. The number of tabulated values will be relatively high. However, since the frequency dependence is relatively weak, Yᵣ^{ref}(ω) and Yᵢ^{ref} (ω), and cᵣ(ω) . . . can be tabulated at a few frequencies and the data can then obtained by interpolation or compressed in other ways such as polynomials or other basis function that are functions of frequency.

Thus, A^{ref}(ω), Fᵣ[Y(ω)], Fⱼ[Y(ω)] can be determined from simulations or experiments. These functions are stored as tabulated values in the storage 218 of the sensing module 200. During a testing procedure, Eq. 18 can be used to determine H(ω) once the step response in the frequency domain, Y(ω), is obtained. The transfer function can then be used for performing seismic data correction, also referred to as equalization. Seismic data correction can be performed in two steps: first the transfer function is corrected (for differences compared to a reference one); secondly, the seismic data are corrected using the corrected transfer function.

As explained further below, the temperature-dependent transfer function (H(ω)), derived from the step test, can be used to produce an inverse filter H⁻¹(ω) that can be used for performing correction on acquired seismic data during a seismic operation. Note that the temperature-dependent H(ω) can be updated before each seismic operation to improve accuracy in seismic data collection.

FIGS. 10A and 10B depict the real and imaginary parts of

$$H ( ω ) - \frac{Y ( ω )}{A ( ω )}$$

at a specific frequency, ω=30 hertz. The vertical axis in FIG. 10A shows the real part of

$$H ( ω ) - \frac{Y ( ω )}{A ( ω )} ,$$

while the vertical axis of FIG. 10B shows the imaginary part of

$$H ( ω ) - \frac{Y ( ω )}{A ( ω )} .$$

The two horizontal axes in FIGS. 10A and 10B are the real part and imaginary part of Y(ω).

Each curve 902 and 904 in respective FIG. 10A and FIG. 10B corresponds to changes in temperature from a first temperature to a second temperature. Note that the real and imaginary parts of

$$H ( ω ) - \frac{Y ( ω )}{A ( ω )}$$

correspond to Fᵣ and Fⱼ in Eq. 18 above.

Another way of determining the transfer function is to use a parametric technique, which is described below. The described method below is described for the geophone accelerometer. It could be used also for a traditional step test of a geophone.

The method is based on a linearization of the analytical expressions for the step response around nominal values of the geophone parameters. It works if the geophone parameters are close to the nominal values. The reason for using this method is that the geophone parameters can be estimated (or determined) using linear methods which can be implemented in digital signal processor (or FPGAs). If the expressions are not linearized, large computer memory and time may be required.

Assume that the transfer function is given as function of the angular frequency ω, and the geophone parameters S (sensitivity), ω₀ (natural frequency), D (damping), Z (DC resistance) and m (mass). For the nominal or reference values of the geophone parameters, a reference transfer function H_{ref}(ω) is defined as follows:

H_{ref}(ω)=H(ω,S,ω₀,D,Z,m). (Eq. 19)

Taylor's formula gives that:

$$H ( ω , S + Δ S , {ω}_{0} + Δ {ω}_{0} , D + Δ D , Z + Δ Z , m + Δ m ) = {H}_{ref} ( ω ) + Δ S \frac{\partial }{\partial S} {H}_{ref} ( ω ) + Δ {ω}_{0} \frac{\partial }{\partial {ω}_{0}} {H}_{ref} ( ω ) + Δ D \frac{\partial }{\partial D} {H}_{ref} ( ω ) + Δ S \frac{\partial }{\partial S} {H}_{ref} ( ω ) + Δ m \frac{\partial }{\partial m} {H}_{ref} ( ω ) , \qquad ( Eq . 20 )$$

where it is assumed that ΔS/S<<1, etc.

In a similar way, the step response is a function of the same parameters:

Y_{ref}(ω)=Y(ω,S,ω₀,D,Z,m) (Eq. 21)

Taylor's formula gives:

$$Y ( ω , S + Δ S , {ω}_{0} + Δ {ω}_{0} , D + Δ D , Z + Δ Z , m + Δ m ) = Y ( ω , S , {ω}_{0} , D , Z , m ) + Δ S \frac{\partial }{\partial S} Y ( ω , S , {ω}_{0} , D , Z , m ) + Δ {ω}_{0} \frac{\partial }{\partial {ω}_{0}} Y ( ω , S , {ω}_{0} , D , Z , m ) + Δ D \frac{\partial }{\partial D} Y ( ω , S , {ω}_{0} , D , Z , m ) + Δ Z \frac{\partial }{\partial Z} Y ( ω , S , {ω}_{0} , D , Z , m ) + Δ m \frac{\partial }{\partial m} Y ( ω , S , {ω}_{0} , D , Z , m ) \qquad ( Eq . 22 )$$

Yₑₓₚ(ω) is determined experimentally, and is defined as:

Yₑₓₚ(ω)=Y(ω,S+ΔS,ω₀+Δω₀,D+ΔD,Z+ΔZ,m+Δm) (Eq. 23)

The difference can be written as:

$$\begin{matrix}Δ Y ( ω ) = {Y}_{exp} ( ω ) - {Y}_{ref} ( ω ) \\ = Δ S \frac{\partial }{\partial S} {Y}_{ref} ( ω ) + Δ ω \frac{\partial }{\partial ω} {Y}_{ref } ( ω ) + \\ Δ D \frac{\partial }{\partial F} {Y}_{ref} ( ω ) + Δ Z \frac{\partial }{\partial Z} {Y}_{ref} ( ω ) + \\ Δ m \frac{\partial }{\partial m} {Y}_{ref} ( ω )\end{matrix} \qquad ( Eq . 24 )$$

The real and imaginary part can be written, respectively, as:

$$\begin{matrix}Re [ Δ Y ( ω ) ] = Δ S Re [ \frac{\partial }{\partial S} {Y}_{ref} ( ω ) ] + Δ ω Re [ \frac{\partial }{\partial ω} {Y}_{ref} ( ω ) ] + Δ D Re [ \frac{\partial }{\partial D} {Y}_{ref} ( ω ) ] + Δ Z Re [ \frac{\partial }{\partial Z} {Y}_{ref} ( ω ) ] + Δ m Re [ \frac{\partial }{\partial m} {Y}_{ref} ( ω ) ] , & ( Eq . 25 ) \\ Im [ Δ Y ( ω ) ] = Δ S Im [ \frac{\partial }{\partial S} {Y}_{ref} ( ω ) ] + Δ ω Im [ \frac{\partial }{\partial ω} {Y}_{ref} ( ω ) ] + Δ D Im [ \frac{\partial }{\partial D} {Y}_{ref} ( ω ) ] + Δ Z Im [ \frac{\partial }{\partial Z} {Y}_{ref} ( ω ) ] + Δ m Im [ \frac{\partial }{\partial m} {Y}_{ref} ( ω ) ] . & ( Eq . 26 )\end{matrix}$$

Data at frequencies ω₁, ω₂, . . . , ω_{M}, can be used, and m≧5 (since there are five parameters). The above can be written as an equation system in matrix form:

$$[ \begin{matrix}Re [ Δ Y ( {ω}_{1} ) ] \\ ⋮ \\ Re [ Δ Y ( {ω}_{M} ) ] \\ Im [ Δ Y ( {ω}_{1} ) ] \\ ⋮ \\ Im [ Δ Y ( {ω}_{M} ) ]\end{matrix} ] [ \begin{matrix}Re [ \frac{\partial }{\partial S} {Y}_{ref} ( {ω}_{1} ) ] & Re [ \frac{\partial }{\partial ω} {Y}_{ref} ( {ω}_{1} ) ] & … & Re [ \frac{\partial }{\partial m} {Y}_{ref} ( {ω}_{1} ) ] \\ ⋮ & & & \\ Re [ \frac{\partial }{\partial S} {Y}_{ref} ( {ω}_{M} ) ] & & & ⋮ \\ Im [ \frac{\partial }{\partial S} {Y}_{ref} ( {ω}_{1} ) ] & & & ⋮ \\ Im [ \frac{\partial }{\partial S} {Y}_{ref} ( {ω}_{M} ) ] & Im [ \frac{\partial }{\partial ω} {Y}_{ref} ( {ω}_{M} ) ] & … & Im [ \frac{\partial }{\partial m} {Y}_{ref} ( {ω}_{M} ) ]\end{matrix} ] [ \begin{matrix}Δ S \\ Δ {ω}_{0} \\ ⋮ \\ Δ m\end{matrix} ] , \qquad ( Eq . 27 )$$

or simply,

E=DP. (Eq. 28)

The parameters given in the vector P can now be determined in the least square sense:

P=(D^{H}D)⁻¹D^{H}E, (Eq. 29)

where H denotes the hermitian transpose.

The determined parameters P=[ΔS Δω₀ . . . Δm]^{T} can be used in Eq. 20 to estimate the transfer function.

The expressions for

$$\frac{\partial }{\partial S} {H}_{ref} ( ω ) , \frac{\partial }{\partial {ω}_{0}} {H}_{ref} ( ω ) , \frac{\partial }{\partial D} {H}_{ref} ( ω ) , \frac{\partial }{\partial S} {H}_{ref} ( ω ) , \frac{\partial }{\partial m} {H}_{ref} ( ω )$$

$$and$$

$$\frac{\partial }{\partial S} Y ( ω ) , \frac{\partial }{\partial {ω}_{0}} Y ( ω ) , \frac{\partial }{\partial D} Y ( ω ) , \frac{\partial }{\partial Z} Y ( ω ) , \frac{\partial }{\partial m} Y ( ω )$$

are determined and stored in memory. These could be determined from an analytical expression of H_{ref}(ω) and Y_{ref}(ω) or could be estimated from circuit simulations. For example,

$$\frac{\partial }{\partial S} {H}_{ref} ( ω ) \approx \frac{{}^{′} 1}{Δ {S}_{ref}} ( H ( ω , S + Δ S , {ω}_{0} , D , Z , m ) - H ( ω , S , {ω}_{0} , D , Z , m ) ) ,$$

where ΔS_{ref} is a small change in around the nominal value S. H(ω,S,+ΔS,ω₀,D,Z,m) and H(ω,S,ω₀,D,Z,m), can be calculated from the simulations.

### Auto-Calibration

In some implementations, sensitivity correction can be performed by the processor 210 (FIG. 1) in a self-contained sensing module. To a first approximation, the sensing module response can be corrected by applying a fixed correction factor to match a reference response, represented as H_{ref}(ω), where H_{ref}(ω) represents the reference transfer function that defines the reference response. By performing such correction, the sensitivity of the sensing module over a defined frequency bandwidth can be improved.

The reference model, represented as H_{ref}(ω), can be stored in tabulated form in a table in the storage 218 of FIG. 2. The correction factor can be computed by a least mean square technique, according to an embodiment.

The frequency dependence sensitivity correction factor, Sₑᵣᵣ(ω), can be calculated as follows:

$$\frac{\vert {H}_{ref} ( ω ) \vert}{\vert {H}_{est} ( ω ) \vert} = 1 + {S}_{err} ( ω ) , \qquad ( Eq . 30 )$$

where Hₑₛₜ(ω) is the transfer function determined according to Eq. 18 discussed above.

From Eq. 30, the following can be obtained:

$${S}_{err} ( ω ) = ( \frac{\vert {H}_{ref} ( ω ) \vert}{\vert {H}_{est} ( ϖ ) \vert} - 1 ) . \qquad ( Eq . 31 )$$

From different values of Sₑᵣᵣ(ω) at different frequencies, an average sensitivity correction factor, S_{cal}, is obtained as follows:

$${S}_{cal} = {\sum }_{i = 1}^{L} v ( {ω}_{i} ) {S}_{err} ( {ω}_{i} ) / ( {\sum }_{i = 1}^{L} v ( {ω}_{i} ) ) , \\ where \\ v ( {ω}_{i} ) = \frac{1}{{ω}_{i}} . \qquad ( Eq . 32 )$$

In other implementations, other spectra weighting functions can be used. The correction factor, S_{cal}, can then be applied to a continuous flow of data in real time to allow a better match from sensing module to sensing module. This technique corrects for the amplitude of the transfer function, but not for its frequency dependence.

In another implementation, instead of correcting for just the amplitude of the transfer function, a complete transfer function correction can be performed as follows. To do so, a coefficient of a matching filter can be computed to adapt the transfer function to a reference model over the complete bandwidth of interest. Using this technique, the inverse of the transfer function is first determined. This technique is commonly referred to as equalization. If the frequency domain input to the sensing module is X(ω), the transfer function is H(ω), and the output signal is Y(ω), then the inverse filter (equalizer) is denoted H⁻¹(ω). The signal after the inverse filter, H⁻¹(ω) is denoted Y′(ω). Consequently, Y′(ω) is computed as follows:

Y(ω)=H(ω)X(ω),

Y′(ω)=H⁻¹(ω)H(ω)X(ω)=X(ω). (Eq. 33)

Notice that H⁻¹(ω)=1/H(ω). In this case, H(ω) is determined from the step test (Eq. 18), and thus H⁻¹(ω) can be readily determined. Applying the inverse filter H⁻¹(ω) to the acquired seismic data collected by the corresponding seismic sensing element provides transfer function correction on the seismic data. Note that the inverse filter H⁻¹(ω) is temperature dependent. If the temperature-dependent transfer function H(ω) is updated before each seismic operation (e.g., once in a morning operation and once in an afternoon operation), then H(ω), and thus H⁻¹(ω), will reflect temperature fluctuations in the system to enable the seismic sensing module to produce more accurate data.

Standard ways of determining a casual digital filter (in the time domain) from a known frequency response can be used. The filter can be either IIR or FIR. Standard methods like the bilinear transformation can also be used.

Another calibration that can be performed by the sensing module is correction for non-linear distortion (where determination of non-linear properties of a seismic sensing module is discussed above). To do so, the inverse of the non-linear transfer function is first determined. Using the Volterra theory, the non-linear transfer function (in time domain) can be written as:

y(t)=H[x(t)]=H₁[x(t)]+H₂[x(t)]+H₃[x(t)],

and the inverse

y′(t)=H⁻¹[y(t)]=H⁻¹[H[x(t)]]=x(t)

y′(t)=H⁻¹[y(t)]=H₁⁻¹[y(t)]+H₂⁻¹[y(t)]+H₃⁻¹[y(t)]+ . . .

Since the seismic system is a weakly linear system with small frequency dependence, H⁻¹ can be readily performed. An advantage of correcting for non-linear distortion is that the signal becomes less distorted. Another advantage is that the dynamic amplitude range of the acquisition change may increase.

The various tasks discussed above can be performed by a local processor in each seismic sensing module. In other implementations, at least one of the tasks can be performed by software which can be loaded for execution on a processor. The processor includes microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A method of testing a seismic sensing module, comprising:
generating, using a local processor associated with a seismic sensing element in the seismic sensing module, a test signal that is applied to the seismic sensing element;
receiving, by the local processor, a response of the seismic sensing element to the test signal; and
determining, by the local processor, at least one characteristic of the seismic sensing module selected from a polarity of the seismic sensing element in the seismic sensing module, a non-linear property of the seismic sensing module, and a temperature-dependent transfer function of the seismic sensing module.

2. The method of claim 1, wherein determining the polarity of the seismic sensing element in the seismic sensing module comprises:
comparing the response of the seismic sensing element to the test signal to an expected profile, the method further comprising:
indicating a correct polarity in response to the response substantially matching the expected profile; and
indicating a reversed polarity in response to the response not matching the expected profile.

3. The method of claim 1, wherein determining the polarity of the seismic sensing element in the seismic sensing module comprises:
receiving a first response of the seismic sensing element in response to the test signal that has a positive polarity; and
receiving a second response of the seismic sensing element in response to another test signal that has a negative polarity.

4. The method of claim 3, further comprising combining the first response and the second response to produce an indication, wherein the indication has a first value to indicate a correct polarity of the seismic sensing element, and a second value to indicate an incorrect polarity of the seismic sensing element.

5. The method of claim 4, wherein the first value is a value less than a predetermined threshold, and wherein the second value is a value greater than the predetermined threshold.

6. The method of claim 1, wherein determining the non-linear property of the seismic sensing module comprises:
comparing measured data points corresponding to the response to a linear response of the seismic sensing module.

7. The method of claim 6, wherein comparing the measured data points to the linear response comprises computing a sum of differences between the measured data points and the linear response for different time points and different step voltages of the test signal.

8. The method of claim 7, further comprising dividing the sum by a number of the step voltages and by a number of the time points to produce a measure of the non-linearity of the seismic sensing module.

9. The method of claim 1, wherein determining the non-linear property of the seismic sensing module comprises calculating a total harmonic distortion.

10. The method of claim 1, wherein determining the temperature-dependent transfer function of the seismic sensing module comprises providing terms in the transfer function that are temperature dependent.

11. The method of claim 10, further comprising determining the terms based on simulations or experiments.

12. The method of claim 10, wherein the temperature-dependent transfer function is one of a parametric transfer function and a non-parametric transfer function.

13. The method of claim 1, further comprising producing a transfer function that accounts for the non-linear property of the seismic sensing module, the method further comprising producing an inverse filter based on the transfer function for applying on seismic data collected by the seismic sensing module during a seismic survey operation to correct for non-linearity of the seismic sensing module.

14. The method of claim 1, further comprising communicating an indication of an incorrect polarity of the seismic sensing element to a control system.

15. The method of claim 1, further comprising disabling the seismic sensing element in response to detecting that the seismic sensing element has an incorrect polarity.

16. A self-contained seismic sensing module having a single housing that contains:
a seismic sensing element;
a processor; and
an interface coupled to the processor and to be coupled to an external network,
wherein the processor is configured to:
generate a test signal applied to the seismic sensing element,
receive a response from the seismic sensing element, and
determine a characteristic of the seismic sensing module according to the response.

17. The self-contained seismic sensing module of claim 16, wherein the determined characteristic comprises a polarity of wired connections to the seismic sensing element.

18. The self-contained seismic sensing module of claim 16, wherein the determined characteristic comprises a non-linear property of the seismic sensing module.

19. The self-contained seismic sensing module of claim 16, wherein the determined characteristic comprises a temperature-dependent transfer function of the seismic sensing module.

20. The self-contained seismic sensing module of claim 16, wherein the generated test signal comprises a step input applied to the seismic sensing element, and wherein the received response comprises a step response.

21. The self-contained seismic sensing module of claim 16, further comprising a temperature sensor in the housing.

22. A seismic sensing module comprising:
a seismic sensing element; and
a processor configured to:
generate a test signal applied to the seismic sensing element,
receive a response from the seismic sensing element; and
determine at least one characteristic of the seismic sensing module according to the response, wherein the at least one characteristic is selected from a polarity of wired connections to the seismic sensing element, a non-linear property of the seismic sensing module, and a temperature-dependent transfer function of the seismic sensing module.

23. The seismic sensing module of claim 22, further comprising a network interface for communication over an external network, wherein the processor is configured to communicate information relating to the at least one characteristic over the external network.
